(19) United States
(12) Patent Application Publication
(10) Pub. No.: US 2018/0113275 A1
(43) Pub. Date: Apr. 26, 2018

(54) FOCUS MECHANISM AND LENS USING SAME

(71) Applicant: DELTA ELECTRONICS, INC., Taoyuan City (TW)

(72) Inventor: Meng-Hsien Shen, Taoyuan City (TW)

(21) Appl. No.: 15/469,222

(22) Filed: Mar. 24, 2017

(30) Foreign Application Priority Data
Oct. 26, 2016 (TW) 105134619

(51) Int. Cl. G02B 7/10

(52) U.S. Cl. CPC G02B 7/10

(57) ABSTRACT

A focus mechanism of a lens assembly includes a cylindrical focus element and at least an auxiliary positioning assembly. The cylindrical focus element is disposed around the lens assembly and has at least a groove having a side wall. Each auxiliary positioning assembly includes a collar and a fix element. The collar is disposed on the groove and the lens assembly, and is partially matched with the side wall of the groove. The fix element is penetrated through the collar and fixed on the lens assembly. When the cylindrical focus element is rotated, the auxiliary positioning assembly is moved relative to the cylindrical focus element along the groove, thereby driving the lens assembly to move and focus. Therefore, the abrasion of the groove is reduced, the precision and stability of the focus operation are increased, and the advantages of enhancing the quality of imaging are achieved.

### CROSS-REFERENCE TO RELATED APPLICATION

This application claims priority from Taiwan Patent Application No. TW 105134619, filed on Oct. 26, 2016, the entire contents of which are incorporated herein by reference for all purposes.

### FIELD OF THE INVENTION

The present invention relates to a focus mechanism, and more particularly to a focus mechanism having an auxiliary positioning assembly and a lens using the same.

### BACKGROUND OF THE INVENTION

In products having lens, such as projections and cameras, increasing and reducing the magnifications of the lens are usually required to adjust the focal lengths. In prior arts, through disposing the rollers at the grooves of the lens housings, the cooperation of the rollers and the grooves can guide and drive the lens to zoom in and zoom out, thereby adjusting the focal lengths. In addition, the grooves have different processing characteristics due to different materials are used.

Generally, during the test stage of the lenses, for the sake of the precision and stability, metal grooves are used. However, during the manufacture stage of the lenses, plastic grooves are commonly used for reducing that the integral weights of the lenses and the manufacturing cost.

However, since the materials of the plastic grooves have lower hardness, the abrasion is easily caused when the rollers is moved in the grooves. Furthermore, when the injection moldings of the plastics are implemented, the draft angles are required for releasing the products from the molds. Nevertheless, the rollers may contact and rub the shapes in the grooves formed due to the draft angles, which results in the abrasion and deformation of the grooves, and makes the lens easily shake and tilt, such that the quality of imaging is affected.

Therefore, there is a need of providing a focus mechanism and a lens using the same to solve the drawbacks in prior arts, reduce the abrasion of the grooves caused by the movement of the rollers, increase the precision and stability of the focus, and achieve the advantages of enhancing the quality of imaging.

### SUMMARY OF THE INVENTION

It is an object of the present invention to provide a focus mechanism and a lens using the same in order to solve the drawbacks of prior art.

The present invention provides a focus mechanism and a lens using the same. By disposing the auxiliary positioning assembly matched with the side wall of the groove, the abrasion of the groove is reduced, and reduces the deformation of the groove, such that the stability of the movement of the auxiliary positioning assembly in the groove is enhanced.

The present invention also provides a focus mechanism and a lens using the same. Through a plane contact is formed between the auxiliary positioning assembly and the groove of the cylindrical focus element, the precision and stability of the focus operation are increased, and the advantages of enhancing the quality of imaging are achieved.

In accordance with an aspect of the present invention, there is provided a focus mechanism of a lens assembly comprising a cylindrical focus element and at least an auxiliary positioning assembly. The cylindrical focus element is rotatably disposed around the lens assembly and has at least a groove, and the groove has a side wall. Each auxiliary positioning assembly comprises a collar and a fix element. The collar is disposed on the groove and the lens assembly, and is partially matched with the side wall of the groove. The fix element is penetrated through the collar and fixed on the lens assembly. When the cylindrical focus element is rotated, the auxiliary positioning assembly is moved relative to the cylindrical focus element along the groove, thereby driving the lens assembly to move and focus.

In accordance with an aspect of the present invention, there is provided a lens comprising a lens assembly and a focus mechanism. The lens assembly comprises a lens element and a housing, and the housing is disposed around the lens element. The focus mechanism comprises a cylindrical focus element and at least an auxiliary positioning assembly. The cylindrical focus element is rotatably disposed around the housing and has at least a groove, and the groove has a side wall. Each auxiliary positioning assembly comprises a collar and a fix element. The collar is disposed on the groove and the housing, and is partially matched with the side wall of the groove. The fix element is penetrated through the collar and fixed on the lens element. When the cylindrical focus element is rotated, the auxiliary positioning assembly is moved relative to the cylindrical focus element along the groove, thereby driving the lens assembly to move and focus.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the structure of a focus mechanism and a lens using the same according to an embodiment of the present invention;

FIG. 2 schematically illustrates the detailed structure of the focus mechanism as shown in FIG. 1; and

FIG. 3 schematically illustrates the sectional view of the focus mechanism as shown in FIG. 2.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

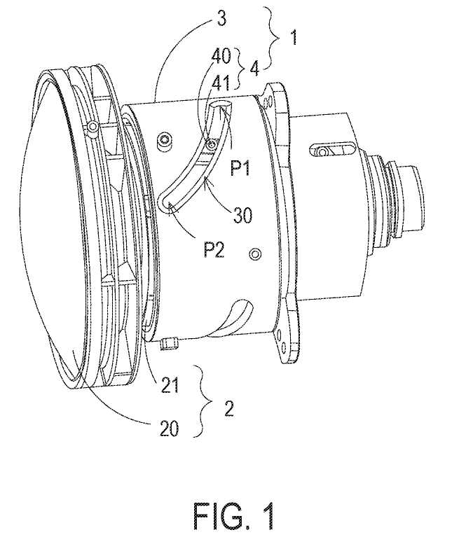

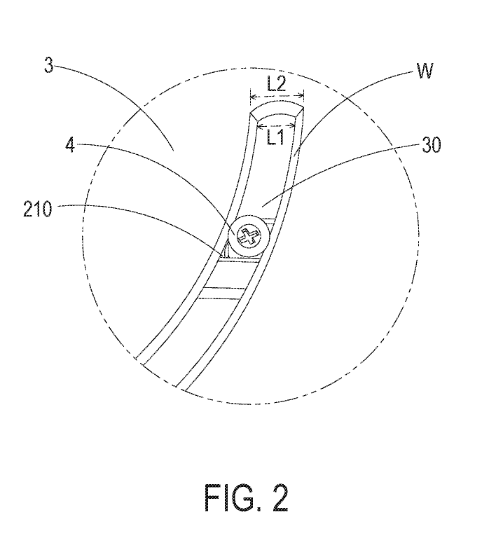

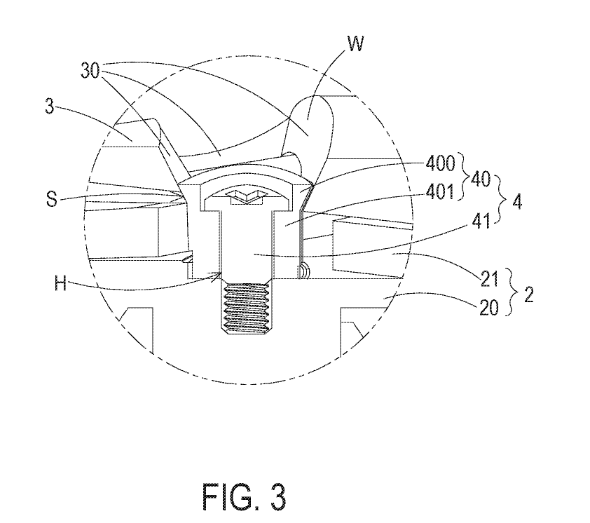

Please refer to FIG. 1, FIG. 2, and FIG. 3. FIG. 1 schematically illustrates the structure of a focus mechanism and a lens using the same according to an embodiment of the present invention. FIG. 2 schematically illustrates the detailed structure of the focus mechanism as shown in FIG. 1. FIG. 3 schematically illustrates the sectional structure of the focus mechanism as shown in FIG. 2. As shown in FIG. 1, FIG. 2, and FIG. 3, the present invention provides a focus mechanism 1 of a lens applied to adjust a lens assembly 2, and the focus mechanism 1 comprises a cylindrical focus element 3 and at least an auxiliary positioning assembly 4. The lens assembly 2 can be a lens assembly applied to projections or cameras, and the auxiliary positioning assembly 4 can be a roller assembly, but not limited herein.

The cylindrical focus element 3 is rotatably disposed around the lens assembly 2 and has at least a groove 30, and the groove 30 has a side wall W. Each auxiliary positioning assembly 4 comprises a collar 40 and a fix element 41. The collar 40 is disposed on the groove 30 and the lens assembly 2, and the collar 40 is partially matched with the side wall W of the groove 30. The fix element 40 is penetrated through the collar 40 and fixed on the lens assembly 2, thereby fixing the collar 40 stably.

When the cylindrical focus element 3 is rotated, the auxiliary positioning assembly 4 is moved relative to the cylindrical focus element 3 along the groove 30, thereby driving the lens assembly 2 to move and focus. In some embodiments, when the cylindrical focus element 3 is rotated, the auxiliary positioning assembly 4 is driven to reciprocate along the groove 30 between a first position point P1 and a second position point P2, thereby stretching the lens assembly 2 to focus. Furthermore, since the auxiliary positioning assembly 4 is fixed on the lens assembly 2, the auxiliary positioning assembly 4 is moved relative to the cylindrical focus element 3 along the groove 30, but not rotated because of the rotation of the cylindrical focus element 3.

In some embodiments, the auxiliary positioning assembly 4 is disposed in the groove 30 and fixed on the lens assembly 2. The method of fixing the auxiliary positioning assembly 4 on the lens assembly 2 can be implemented by burying auxiliary positioning assembly 4 into the lens assembly 2, embedding the auxiliary positioning assembly 4 into the lens assembly 2, or penetrating the auxiliary positioning assembly 4 through the lens assembly 2, but not limited thereto. In addition, the collar 40 can be a roller, and the fix element 41 can be a screw, but not limited herein.

In some embodiments, the collar 40 further comprises a head part 400 and an extension part 401. The head part 400 has an outer peripheral surface S, and the outer peripheral surface S is matched with the side wall W of the groove 30. The extension part 401 of the collar 40 is extended from the head part and has a perforation H, and the fix element 41 is penetrated through the perforation H and then fixed on the lens assembly 2.

In some embodiments, the outer peripheral surface S of the head part 400 is a tapered surface, which is a surface tapering along the direction from the head part 400 to the extension part 401, such that the outer peripheral surface S is matched with the side wall W of the groove 30, and a plane contact is formed between the auxiliary positioning assembly 4 and the groove 30. Furthermore, the materials of the cylindrical focus elements 3 are usually plastics, which require draft angles while processing and modeling for easily releasing the products from the molds, so the width of the inner length L1 of the groove 30 is less than the width of the outer length L2 of the groove 30, and the outer peripheral surface S of the head part 400 is an inclined plane for matching with the side wall W of the groove 30 having draft angles. That is to say, when the side wall W of the groove 30 tapers from outside to inside, the head part 400 is matched with the tapered contour of the side wall W through the same angles. In some embodiments, the upper edge of the head part 400 has a first perimeter, the connection part between the head part 400 and the extension part 401 has a second perimeter, and the first perimeter is greater than the second perimeter, such that the outer peripheral surface can be a tapered surface, but not limited herein.

In brief, the present invention provides a focus mechanism. By disposing the auxiliary positioning assembly matched with the side wall of the groove, such that a plane contact is formed between the auxiliary positioning assembly and the groove of the cylindrical focus element. Therefore, the abrasion of the groove is reduced, and the stability of the movement of the auxiliary positioning assembly in the groove relative to the cylindrical focus element is enhanced, such that the advantages of enhancing the quality of imaging are achieved. It is noted that the focus mechanism of the present invention can be applied to prime lenses and zoom lenses. Practically, the focus mechanism can be applied to adjust the lens distance (zoom in/out), appropriate focal lengths or other optical properties related to the lens, such as the switching of filters or apertures (not shown). In brief, the focus mechanism can be applied to lens adjustment of physical properties upon mechanism, and the applications can be understood by the person having ordinary skill in the art according to the concepts of the present invention.

In some embodiments, the lens assembly 2 further comprises a lens element 20 and a housing 21. The housing 21 is disposed around the lens element 20, the cylindrical focus element 3 is rotatably disposed around the housing 21, the collar 40 is disposed on the housing 21, and the fix element 41 is fixed on the lens element 20, thereby constructing the focus mechanism 1 and the lens assembly 2 as a lens for applying to devices such as projections or cameras.

That is to say, the present invention provides a lens comprising a focus mechanism 1 and a lens assembly 2. The lens assembly 2 comprises a lens element 20 and a housing 21, and the housing 21 is disposed around the lens element 20. The focus mechanism 1 comprises a cylindrical focus element 3 and at least an auxiliary positioning assembly 4. The cylindrical focus element 3 is rotatably disposed around the housing 21 and has at least a groove 30, and the groove 30 has a side wall W. Furthermore, each auxiliary positioning assembly 4 comprises a collar 40 and a fix element 41. The collar 40 is disposed on the groove 30 and the housing 21, and is partially matched with the side wall W of the groove 30. The fix element 41 is penetrated through the collar 40 and fixed on the lens element 20. When the cylindrical focus element 3 is rotated, the auxiliary positioning assembly 4 is moved relative to the cylindrical focus element 3 along the groove 30, thereby driving the lens assembly to move and focus.

In some embodiments, the housing 21 further has at least a vertical trench 210 disposed corresponding to the groove 30. For example, the vertical trench 210 of the housing 21 is disposed along the stretching direction of focusing the lens assembly 2, such that when the auxiliary positioning assembly 4 is moved along the vertical trench 210, the auxiliary positioning assembly 4 is moved along the groove 30 simultaneously, thereby driving the lens assembly 2 to focus. The groove 30, the auxiliary positioning assembly 4 and the vertical trench are disposed correspondingly, and the amounts of them are not limited to one, respectively.

In some embodiments, the fix element 41 is a screw having a screw head and a threaded part. The screw head is engaged to the head part 400 of the collar 40, and the threaded part is penetrated through the perforation H and is screwed with the lens element 20, thereby fixing the auxiliary positioning assembly 4 on the lens assembly 2 integrally, such that the lens assembly 2 is driven to stretch while focusing.

In some embodiments, the groove 30 is a curved groove, and the curved groove is extended along a cylindrical surface of the cylindrical focus element 3. For example, the cylindrical focus element 3 of the focus mechanism has three grooves 30, which are distributed evenly on the cylindrical surface of the cylindrical focus element 3, such as disposed 120 degrees away to each other respectively on the 360 degrees cylindrical focus element 3. Furthermore, the focus mechanism 1 has three auxiliary positioning assemblies 4 disposed correspond to three grooves 30 respectively, and when the cylindrical focus element 3 is rotated, three auxiliary positioning assemblies 4 are moved relative to the cylindrical focus element 3 along three grooves 30, thereby driving the lens assembly 2 to move and focus, but not limited thereto.

From the above description, the present invention provides a focus mechanism and a lens using the same. By disposing the auxiliary positioning assembly matched with the side wall of the groove, the abrasion of the groove is reduced, and reduces the deformation of the groove, such that the stability of the movement of auxiliary positioning assembly in the groove is enhanced. Furthermore, through a plane contact is formed between the auxiliary positioning assembly and the groove of the cylindrical focus element, the precision and stability of the focus operation are increased, and the advantages of enhancing the quality of imaging are achieved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A focus mechanism of a lens assembly, comprising:
a cylindrical focus element rotatably disposed around the lens assembly, wherein the cylindrical focus element has at least a groove, and the groove has a side wall; and
at least an auxiliary positioning assembly, wherein each auxiliary positioning assembly comprises:
a collar disposed on the groove and the lens assembly and partially matched with the side wall of the groove; and
a fix element penetrated through the collar and fixed on the lens assembly,
wherein when the cylindrical focus element is rotated, the auxiliary positioning assembly is moved relative to the cylindrical focus element along the groove, thereby driving the lens assembly to move and focus.

2. The focus mechanism according to claim 1, wherein the collar further comprises:
a head part having an outer peripheral surface, wherein the outer peripheral surface is matched with the side wall of the groove; and
an extension part having a perforation, wherein the fix element is penetrated through the perforation.

3. The focus mechanism according to claim 2, wherein the outer peripheral surface of the head part is a tapered surface.

4. The focus mechanism according to claim 2, wherein the width of the inner length of the groove is less than the width of the outer length of the groove, and the outer peripheral surface of the head part is an inclined plane.

5. The focus mechanism according to claim 1, wherein the lens assembly further comprises a lens element and a housing, wherein the housing is disposed around the lens element, the cylindrical focus element is rotatably disposed around the housing, the collar is disposed on the housing, and the fix element is fixed on the lens element.

6. The focus mechanism according to claim 5, wherein the housing further has at least a vertical trench disposed corresponding to the groove, and wherein when the auxiliary positioning assembly is moved along the vertical trench, the auxiliary positioning assembly is moved along the groove simultaneously, thereby driving the lens assembly to focus.

7. The focus mechanism according to claim 5, wherein the fix element is a screw having a screw head and a threaded part, and wherein the screw head is engaged to the head part of the collar, and the threaded part is penetrated through the perforation and is screwed with the lens element.

8. The focus mechanism according to claim 1, wherein when the cylindrical focus element is rotated, the auxiliary positioning assembly is driven to reciprocate along the groove between a first position point and a second position point, thereby stretching the lens assembly.

9. The focus mechanism according to claim 1, wherein the groove is a curved groove, and the curved groove is extended along a cylindrical surface of the cylindrical focus element.

10. A lens, comprising:
a lens assembly comprising a lens element and a housing, wherein the housing is disposed around the lens element; and
a focus mechanism comprising:
a cylindrical focus element rotatably disposed around the housing, wherein the cylindrical focus element has at least a groove, and the groove has a side wall; and
at least an auxiliary positioning assembly, wherein each auxiliary positioning assembly comprises:
a collar disposed on the groove and the housing, and partially matched with the side wall of the groove; and
a fix element penetrated through the collar and fixed on the lens element;
wherein when the cylindrical focus element is rotated, the auxiliary positioning assembly is moved relative to the cylindrical focus element along the groove, thereby driving the lens assembly to move and focus.
